(19) United States
(12) Patent Application Publication
(10) Pub. No.: US 2023/0306456 A1
(43) Pub. Date: Sep. 28, 2023

(54) MERGING USER STRUCTURES INTO A MULTI-LINE STRUCTURE THAT PROVIDES LEADERSHIP AWARDS

(71) Applicant: KWIKCLICK, LLC, Murray, UT (US)

(72) Inventor: Fred Cooper, Farmington, UT (US)

(21) Appl. No.: 18/090,476

(22) Filed: Dec. 28, 2022

Related U.S. Application Data
(63) Continuation-in-part of application No. 17/867,356, filed on Jul. 18, 2022, now abandoned.
(60) Provisional application No. 63/222,818, filed on Jul. 16, 2021.

(51) Int. Cl. G06Q 30/0214; G06Q 30/0207

(52) U.S. Cl. CPC G06Q 30/0214; G06Q 30/0239

(57) ABSTRACT

Disclosed herein is a system and method to any two or more MLMs to be merged into a multiline MLM system despite having different commission structures. Each member of the original MLMs is able to maintain their existing downlines without any changes. Further the existing MLM members have full access to the multi-line MLM commission structure, for example, a member of a binary MLM may now add a 3rd, 4th, 5th, etc. line if they choose. The multiline commission plan will be different than the commission plans from any of the original MLMs but this change should not affect the income of a large portion of users, and users that are affected by the changeover can be compensated or made whole on an individual level. In addition to this multiline commission plan, the commission structure of the original MLMs has been broken into several separate ‘types’ which together form a MLM system. These ‘types’ include the income received from downline commission based on position and the income received based on enrolling a member in the MLM, also known as sponsorship. Another income type are the bonuses earned through leadership status. Members are rewarded based on their contributions to the MLM, and the most influential and/or high earning members are encouraged to continue to grow the MLM through these bonuses. The system provides example methods of how theses leadership bonuses can be applied based on efforts made by a member in the new MLM, while also being augmented based on their original MLM.

### CROSS-REFERENCE TO RELATED APPLICATION

The present application is a continuation-in part and claims priority benefit of U.S. patent application 17/867,356 filed Jul. 18, 2022, which claims the priority benefit of U.S. provisional application number 63/222,818 filed Jul. 16, 2021, the disclosure of which is incorporated herein by reference.

### BACKGROUND OF THE INVENTION

### 1. Field of the Disclosure

The present disclosure is generally related to merging multi-level marketing systems.

### 2. Description of the Related Art

Multi-Level Marketing (MLM) companies are defined by a commission structure that is multi-level, such that a commission is paid to at least one member above the member who made a sale or purchase. However, there are multiple kinds of commission structures, for example, binary, matrix, or unilevel. Merging these companies while maintaining the integrity of the existing commission structure has been unsuccessful when the two companies do not have the same kind of commission structure. Usually, when companies with a different commission structure do merge, the two commission structures are simply kept separate and retain their traits and commission rates. Therefore, members of a traditional unilevel, binary, or matrix commission structure must continue to build that structure even if other members of the merged company are in a multi-level structure. If the merged company does decide to attempt to merge the commission structures, it often ends with members feeling disoriented or upset by changes that can impact income from commissions. Further, individual MLMs often have leadership programs and associated bonuses that reward member for hard work in building and continuing to build the distribution network. Losing these bonuses due to a merger, without replacement, could frustrate and alienate members. There is a need for existing MLM companies to merge without having to either continue to keep the two or more companies separate or upset members by rearranging the existing commission structures.

### BRIEF DESCRIPTION OF THE DRAWINGS

FIG. 1 illustrates a Multi-Level Marketing Merger System

FIG. 2 illustrates a Unilevel MLM User Structure

FIG. 3 illustrates a Binary MLM User Structure

FIG. 4 illustrates a Matrix MLM User Structure

FIG. 5 illustrates a Multiline MLM User Structure

FIG. 6 illustrates a Multiline MLM Commission Module

FIG. 7 illustrates a Multiline MLM Additional Line Module

FIG. 8 illustrates a Multiline MLM Merger Module

FIG. 9 illustrates a Merged MLM Merged Commission Module

FIG. 10 illustrates a Merged MLM Leadership Module.

FIG. 11 illustrates a Merged MLM Leadership Bonus Module.

### DETAILED DESCRIPTION

Systems and methods for a Multi-Level Marketing Merger System are disclosed. The system includes Multiline MLM organization, which is a distribution organization characterized by a multi-level payment structure. In a Multiline MLM organization, a user is a distributor or a sales agent and may earn commission based on their own sales and the sales of other users. The user may have one or more users above the user in the organization structure, who are referred to as upline user. When the user makes a sale, the user may pay commission to one or more upline users. The user may have one or more users below the user in the organization structure, which is referred to as downline user. The user may receive commission from the downline users who have made a sale. The Multiline MLM organization may allow the user to have an infinite number of lines below the user, each line representing another user. Alternatively, the distribution organization may limit the number of downline users a user can have at a fixed number and only increase the number of downlines if the user has met a certain threshold criteria. In the case where the user has recruited a new user but has not met the criteria to open a new downline, the user may only retain the status as a sponsor or a recruiter but not be an upline user to the new user. Users who are in a relationship of receiving or paying commission to one another but not in each other’s downline or upline are in a crossline relationship. For example, the sponsor who recruited the user may or may not be an upline user to the user in the Multiline MLM organization but still receive commission from the user via the crossline relationship. The commission rate paid to an upline user may be different from a crossline user or an upline user who is also the sponsor.

In contrast, a Unilevel, Binary, or Matrix MLM limit connections between users and sponsors based on structural differences. A Unilevel MLM lacks crossline relationship because the sponsor that recruited the user is an upline user of the user. The Unilevel MLM organization may have an infinite number of lines below the user as new recruits are recruited by the user. A Matrix MLM lacks crossline relationship because the sponsor that recruited the user is an upline user of the user. The Matrix MLM organization has a fixed width and depth of lines below the user as new recruits are recruited by the user. In the Matrix and Unilevel MLM a downline user pays commission to the upline user when a sale is made by the downline user. A Binary MLM restricts a sponsor to connect with only two downline users. If a sponsor that is already connected to two downline users recruits new users, the new users are placed in a different user downline. A crossline relationship may be created between the sponsor and the newly recruited user and the sponsor may receive commission related to the crossline relationship. However, the sponsor may not receive upline commission from the newly recruited users or the downline of the newly recruited users.

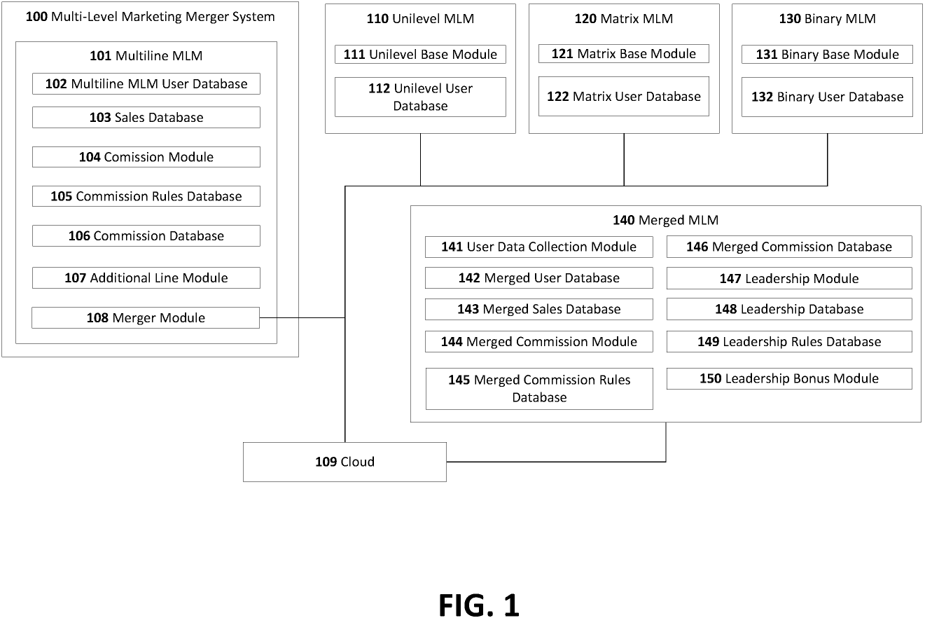

Merging the users of a Unilevel, Binary, or Matrix MLM into a Multiline MLM may require position and user connection changes for users of the different structures. Users of the Multiline MLM may have a maximum number of users possible as downline users until a commission threshold is reached, while Unilevel, Binary, and Matrix MLM users do not add possible downline users based on a commission threshold. The Multi-Level Marketing Merger System may instantaneously reorganize connections and positions of the users from the Unilevel, Binary, or Matrix MLM into the Multiline MLM to reconcile different commission rules from two or more organizations with different structures to find the optimal commission structures for users and maximize commission rates. This allows for a seamless transition without an interruption in the businesses. The Multi-Level Marketing Merger System may reorganize the different structures by creating crossline connections to sponsors and placing users in the downline of different users while maintaining the possible commission earned for each user. Based on commission rules in the Unilevel, Binary, or Matrix MLM and commission rules in the Multiline MLM the Multi-Level Marketing Merger System may update rules in the Multiline MLM associated with a user and the position of the user to ensure the possible commission earned by the user is comparable after the merger. The process for comparing and merging the systems is described in detail in FIGS. 1-9.

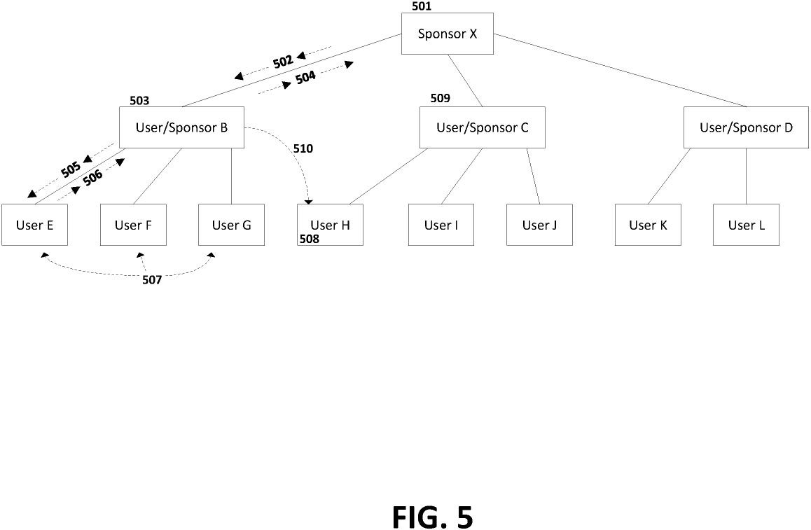

FIG. 1 illustrates a Multi-Level Marketing Merger System 100. The system includes a Multiline MLM organization 101, which in turn includes a Multiline MLM User Database 102, a Sales Database 103, a Commission Module 104, a Commission Rules Database 105, a Commission Database 106, an Additional Line Module 107, and a Merger Module 108. Structure of the Multiline MLM organization 101 is discussed in further detail in FIG. 5. The Multiline MLM User Database 102 may contain information about a user in the Multiline MLM organization structure, including data such as a user ID of the user, the ID of an upline user directly above the user, the ID of a sponsor user that enrolled the user in the Multiline MLM, the type of relationship between the user and other users, the position of the user in the organization hierarchy, and how many downlines the user is currently allowed. The type of relationship indicates whether the user is a sponsor, upline user, or downline user to other users. The Multiline MLM Sales Database 103 may contain data on sales made by the user, such as a user ID, a sale value, and a transaction date.

A Multiline MLM Commission Module 104 may receive data from the Multiline MLM Sales Database 103 to pay commissions to one or more other users. The Multiline MLM Commission Rules Database 105 may contain rules to calculate commission based on the position of the user in the Multiline MLM User Database 102 and sales data in the Multiline MLM Sales Database 103. The 104 Multiline MLM Commission Module may calculate commission based on sales data in the Multiline MLM Sales Database 103, the position of the user in the Multiline MLM User Database 102, and rules stored in the Multiline MLM Commission Rules Database 105 corresponding to the sales data and the position of the user. The calculated commission may be stored in the Multiline MLM Commission Database 106. In some embodiments, the Multiline MLM Commission Module 104 may pay users directly. The Multiline MLM Additional Line Module 107 may receive data from the Multiline MLM Commission Database 106 to determine if the user qualifies for an additional line.

The Multiline MLM Additional Line Module 107 may determine if the user has met a threshold commission value on their existing lines based on data from the Multiline MLM Commissions Database 106 and may add an additional line to the number of lines that the user is allowed. The Multiline MLM Additional Line Module 107 may update the Multiline MLM User Database 102, the Multiline MLM Commission Module 104, or any combination of databases with additional line data the user is allowed. In some embodiments, the Multiline MLM Commission Module 104 may calculate and store an additional commission for the user based on the additional line data. The Multiline MLM Merger Module 108 may receive data via a Cloud 109 from any number of MLM structures, such as a Unilevel MLM 110, a Matrix MLM 120, and a Binary MLM 130. The Cloud 109 may also send or receive data from the Merged MLM 140. The Cloud 109 or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economies of scale.

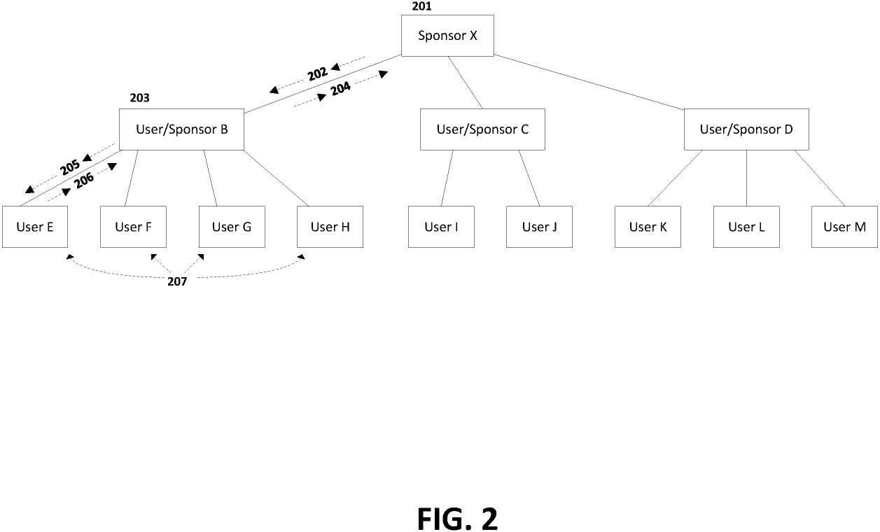

The Unilevel MLM organization 110 may include a distribution organization characterized by a Unilevel payment structure wherein a user of the organization is a distributor and pays commission to a sponsor user above the user in the distribution organization. The user in the Unilevel MLM organization 110 may also be a sponsor user by recruiting and adding a new user in a single line below the user. The sponsor user may receive commission from an infinite number of new users in the single line below the sponsor user. Structure of the Unilevel MLM organization 110 is discussed in further detail in FIG. 2. A Unilevel MLM Base Module 111 may extract data stored in a Unilevel MLM User Database 112 including information about the position of the user in the Unilevel MLM distribution organization structure, such as the sponsor user that enrolled the user in the Unilevel MLM, position of other users directly below the user in the user downline, position of other users directly above the user in the user upline, and commission rules of the Unilevel MLM distribution organization for the user. The Unilevel MLM Base Module 111 may send extracted data via the Cloud 109 to the Multiline MLM Merger Module 108 to be stored in the Multiline MLM User Database 102, the Multiline MLM Commission Rules Database 105, or any combination of databases in the 101 Multiline MLM system and the 140 Merged MLM.

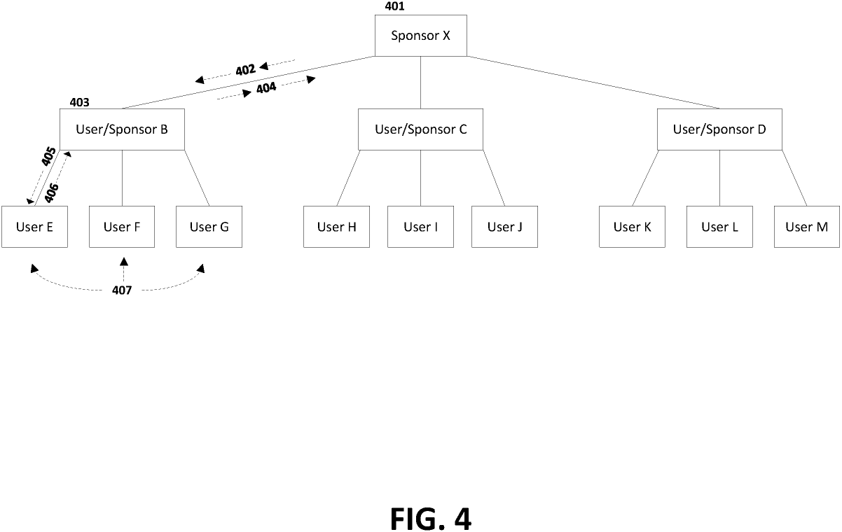

The Matrix MLM organization 120 may include a distribution organization characterized by a Matrix payment structure wherein a user of the organization is a distributor and pays commission to a sponsor user above the user in the distribution organization. The user in the Matrix MLM organization 120 may also be a sponsor user by recruiting and adding a new user in a matrix below the user. The sponsor user may receive commission from a fixed number of new users in the matrix below the sponsor user. Structure of the Matrix MLM organization 120 is discussed in further detail in FIG. 4. A Matrix MLM Base Module 121 may extract data stored in a Matrix MLM User Database 122 including information about the position of the user in the Matrix MLM distribution organization structure, such as the sponsor user that enrolled the user in the Matrix MLM, position of other users directly below the user in the user downline, position of other users directly above the user in the user upline, and commission rules of the Matrix MLM distribution organization for the user. The Matrix MLM Base Module 121 may send extracted data via the Cloud 109 to the Multiline MLM Merger Module 108 to be stored in the Multiline MLM User Database 102, the Multiline MLM Commission Rules Database 105, or any combination of databases in the 101 Multiline MLM system and the 140 Merged MLM.

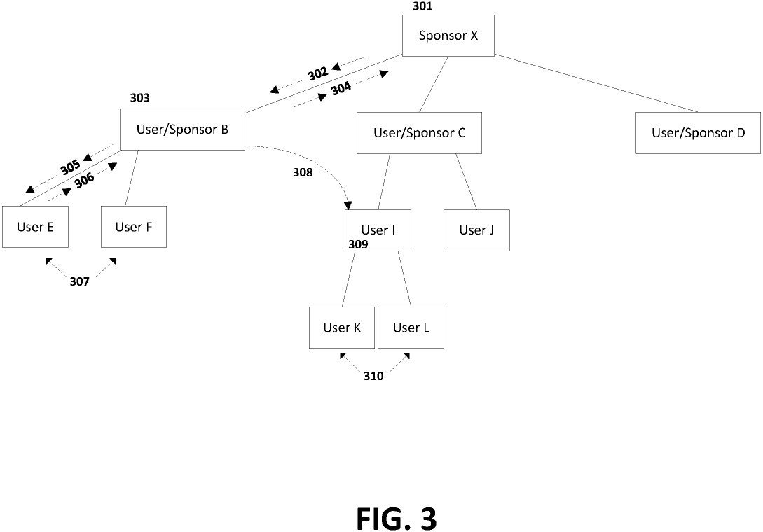

The Binary MLM organization 130 may include a distribution organization characterized by a Binary payment structure wherein a user of the organization is a distributor and pays commission to a sponsor user above the user in the distribution organization. The user in the Binary MLM organization 130 may also be a sponsor user by recruiting and adding a new user in a single line below the user. The sponsor user may receive commission from two users in a downline below the sponsor user, and an infinite number of users with a crossline sponsor connection. Structure of the Binary MLM organization 130 is discussed in further detail in FIG. 3. A Binary MLM Base Module 131 may extract data stored in a Binary MLM User Database 132 including information about the position of the user in the Binary MLM distribution organization structure, such as the sponsor user that enrolled the user in the Binary MLM, position of other users directly below the user in the user downline, position of other users directly above the user in the user upline, and commission rules of the Binary MLM distribution organization for the user. The Binary MLM Base Module 131 may send extracted data via the Cloud 109 to the Multiline MLM Merger Module 108 to be stored in the Multiline MLM User Database 102, the Multiline MLM Commission Rules Database 105, or any combination of databases in the 101 Multiline MLM system and the 140 Merged MLM.

A 141 Merged MLM User Data Collection Module may receive user data from the 108 Multiline MLM Merger Module, which is then stored in the 142 Merged MLM Merged User Database and contains data on users from the other MLMs that were merged to create the 140 Merged MLM. A 142 Merged MLM Merged User Database contains information on user’s position in the 140 Merged MLM commission structure, who enrolled or sponsored the user in the 140 Merged MLM or one of the MLMs that merged into the 140 Merged MLM, the number of lines that user is allowed under a multiline commission structure, and the MLM ID of the user’s original MLM. A 143 Merged MLM Merged Sales Database contains data on sales made by users, which is used by the 144 Merged MLM Merged Commission Module to pay commissions to other users. A 144 Merged MLM Merged Commission Module calculates commission based on new sales data in the 143 Merged MLM Merged Sales Database and stores that commission in the 146 Merged MLM Merged Commission Database. In some embodiments the 144 Merged MLM Merged Commission Module may also pay users directly. A 145 Merged MLM Merged Commission Rules Database which stores commission rules which are used by the 144 Merged MLM Merged Commission Module to determine commissions. A 146 Merged MLM Merged Commission Database stores commissions calculated by the 146 Merged MLM Merged Commission Module. In some embodiments this data may be used by another module to pay commissions to users.

147 Merged MLM Leadership Module may assign a user a leadership score based on metrics such as available lines, commissions, MLM of origin, total line depth, etc. The rules for theses scores are extracted from the 149 Merged MLM Leadership Rules Database and the total score is stored in the 148 Merged MLM Leadership Database.

A 148 Merged MLM Leadership Database may contain user’s leaderships scores as determined by the 147 Merged MLM Leadership Module. Each entry in the database may contain a user ID, for example, UL014, and a leadership score, for example, 4039. In some embodiments historical leadership score data may also be stored.

A 149 Merged MLM Leadership Rules Database contains rules on how a specific metric should be converted to leadership score. For example, a user may receive 10 leadership score for each available line, and leadership score equal to the square root of total commissions. A 150 Merged MLM Leadership Bonus Module may assign bonuses based on leadership score from the 148 Merged MLM Leadership Database. Each entry in the 149 Merged MLM Leadership Rules Database may contain a type, for example, commissions, and a rule, for example, “leadership score = (total commissions)^(½).”

FIG. 2 illustrates a Unilevel MLM User Structure. In Unilevel MLM User structure, there are only upline and downline relationships between sponsors and those who are recruited by the sponsors. A user that is recruited to the organization by a sponsor becomes the downline of the sponsor. For example, Sponsor X 201 who recruited User/Sponsor B 203 may be connected to User/sponsor B 203 via an immediate downline connection 202. In the Unilevel MLM User Structure, any number of users recruited by Sponsor X 201 may be connected to Sponsor X 201 via an immediate downline connection 202. A User/Sponsor 203 may be connected to the Sponsor 201 via an immediate upline connection 204. The User/Sponsor B 203 may also recruit and connect to any number of users 207 via an immediate downline connection 205 and each of the any number of users 207 may be connected to the User/Sponsor 203 via an immediate upline connection 206. The Unilevel MLM User Structure may allow Sponsor X 201 to receive commission from each User/Sponsor 203 with an immediate upline connection to the Sponsor X 201. The Sponsor X 201 may also receive commission from any number of users 207 that have an immediate upline connection 206 to the User/Sponsor 203 that also has an immediate upline connection 204 with the Sponsor X 201. For example, User E may pay commission to User/Sponsor B 203 and Sponsor X 201. In some embodiments, the Sponsor X 201 may only receive commission from users with immediate upline connections to the Sponsor X 201. Depending on the position of the user in the organization hierarchy, the rate of commission may vary. For example, Users E, F, G, and H may receive one rate of commission whereas Users B, C, D may receive another rate of commission that is different. Additionally, the commission rate may vary based on the relationship between the users. For example, User/Sponsor B may receive a certain rate of commission from User E whereas Sponsor X may receive a different rate of commission from User E.

FIG. 3 illustrates a Binary MLM User Structure. In Binary MLM User structure, there are only two possible downline relationships between sponsors and those who are recruited by the sponsors. A user that is recruited to the organization by a sponsor becomes the downline of the sponsor if the sponsor does not yet have two users in the downline. For example, Sponsor X 301 who recruited User/Sponsor B 303 may be connected to User/sponsor B 303 via an immediate downline connection 302. In the Binary MLM User Structure, two users recruited by Sponsor X 301 may be connected to Sponsor X 301 via an immediate downline connection 302. A User/Sponsor 303 may be connected to the Sponsor 301 via an immediate upline connection 304. The User/Sponsor B 303 may also recruit and connect to two users 307 via an immediate downline connection 305 and each of the two users 307 may be connected to the User/Sponsor 303 via an immediate upline connection 306. The Binary MLM User Structure may allow Sponsor X 301 to receive commission from each User/Sponsor 303 with an immediate upline connection to the Sponsor X 301. The Sponsor X 301 may also receive commission from any number of users 307 that have an immediate upline connection 306 to the User/Sponsor 303 that also has an immediate upline connection 304 with the Sponsor X 301. For example, User E may pay commission to User/Sponsor B 303 and Sponsor X 301. In some embodiments, the Sponsor X 301 may only receive commission from users with immediate upline connections to the Sponsor X 301. Depending on the position of the user in the organization hierarchy, the rate of commission may vary. For example, Users E, F, G, and H may receive one rate of commission whereas Users B, C, D may receive another rate of commission that is different. Additionally, the commission rate may vary based on the relationship between the users. For example, User/Sponsor B may receive a certain rate of commission from User E whereas Sponsor X may receive a different rate of commission from User E.

A sponsor, such as Sponsor X 301, that is connected to two downline users may recruit crossline users 309 and connect with the crossline users via a crossline sponsors connection 308. The sponsor may receive a different commission rate for crossline users connected via a crossline sponsor connection 308 compared to the commission rate for users in the downline connection 302. Further, the sponsor may not receive commission from subsequent users 310 recruited by crossline users 309. For example, User/Sponsor B may receive 10% commission from User E and User F in the downline of User/Sponsor B. User/Sponsor B may also receive 5% commission from users recruited in the future by User E and User F that are placed in the downline of User E, User F, and User/Sponsor B. User/Sponsor B may receive a different commission rate from User I through a crossline connection 308, such as 12% crossline commission. However, User/Sponsor B will not receive commission from User K and User L 310 recruited by User I, as User I only has a crossline connection with User/Sponsor B.

FIG. 4 illustrates a Matrix MLM User Structure. In Matrix MLM User structure, there are only upline and downline relationships between sponsors and those who are recruited by the sponsors. A user that is recruited to the organization by a sponsor becomes the downline of the sponsor. The sponsor may recruit new users to fill any open position in a matrix structure until the matrix is filled with a user in each position. The matrix structure is defined by the number of immediate downlines or width, and the number of levels of downlines or depth. For example, Sponsor X 401 who recruited User/Sponsor B 403 may be connected to User/sponsor B 403 via an immediate downline connection 402. In the Matrix MLM User Structure, a fixed number of users may be recruited by Sponsor X 401 based on the number of available positions in the matrix. The matrix structure in FIG. 4 is an example of a 3x2 matrix. In this example, each sponsor may have three immediate downlines, and each of the immediate downlines may have three further downlines, for a total of twelve positions. The matrix structure may use any combination of two numbers to define the number of downlines and the number of levels to create a matrix structure. User/Sponsor B 403 may be connected to Sponsor X 401 via an immediate downline connection 402. A User/Sponsor B 403 may be connected to the Sponsor 401 via an immediate upline connection 404. The User/Sponsor B 403 may connect to a fixed number of users 407 via an immediate downline connection 405. The fixed number of users 407 may be recruited by either Sponsor X 401 or User/Sponsor B 403 and may connect to User/Sponsor B 403 and Sponsor X 401 via an upline connection 406. The Matrix MLM User Structure may allow Sponsor X 401 to receive commission from each user with an upline connection to the Sponsor X 401 until the matrix is occupied by a user in each position. The Sponsor X 401 may not receive commission from any number of users in a downline outside the matrix structure, such as users recruited by the fixed number of users 407. For example, User E may pay commission to User/Sponsor B 403 and Sponsor X 401, but any users recruited by User E may not pay commission to Sponsor X 401. Depending on the position of the user in the organization hierarchy, the rate of commission may vary. For example, Users E, F, G, and H may receive one rate of commission whereas Users B, C, D may receive another rate of commission that is different. Additionally, the commission rate may vary based on the relationship between the users. For example, User/Sponsor B may receive a certain rate of commission from User E whereas Sponsor X may receive a different rate of commission from User E.

FIG. 5 Illustrates a Multiline MLM User Structure. A Multiline MLM User Structure may include at least a Sponsor and a User wherein the Sponsor is a salesperson that has recruited the User to the Multiline MLM organization. A Sponsor 501 may be connected to one or more users via an immediate downline connection 502, such as the immediate downline connection 502 between Sponsor 501 and User/Sponsor 503. A User/Sponsor 503 may be connected to the Sponsor 501 via an immediate upline connection 504. The User/Sponsor 503 may also recruit and connect to any number of users 507 via an immediate downline connection 505 and each of the any number of users 507 may be connected to the User/Sponsor 503 via an immediate upline connection 506.

The Multiline MLM User Structure, may limit the number of users connected to a sponsor (i.e. Sponsor 501 or User/Sponsor 503) via an immediate downline connection. This limitation may be configured as a rule in the Multiline MLM User Database 102. A maximum number of users connected to the sponsor via an immediate downline connection rule may be configured based on various factors including but not limited to the position of the user or sponsor in the Multiline MLM User Structure, the number of upline connections connected to the user or sponsor, the number of downline connections connected to the user or sponsor, the total commission earned by the user or sponsor, the total sales made by the user or sponsor, the commission earned from each of the downlines of the user or sponsor, or any combination therein. For example, the Multiline MLM User Structure in FIG. 5 may include a rule that allows for a maximum of 4 users connected to the User/Sponsor 503 via an immediate downline connection 505. The User/Sponsor 503 may recruit a new user 508. In the case that the User/Sponsor 503 is already connected to the maximum number of users allowed via an immediate downline, the new user 508 may be placed in an immediate downline of a different user 509. The User/Sponsor 503 may be connected to the new user 508 via a sponsor connection 510. The maximum number of users connected to a sponsor may be raised if the sponsor has met a threshold criteria. The threshold criteria may include the sales amount of the user that exceeds a threshold amount, commission received from each downline that exceeds a threshold amount, and total commission received from all the downline of the user exceeding a threshold amount. Further, the threshold criteria may be weighted based on the relationship between users. For example, a commission received as an upline may be weighted heavier than the commission received as a sponsor towards determining whether the user is eligible for an additional line. The threshold amount a user must meet may vary based on the number of downlines the user already has and the position of the user in the organization hierarchy.

The Multiline MLM User Structure may allow a sponsor to receive commission from each user with an immediate upline connection to the sponsor, such as the User/Sponsor 503 receiving commission from the any number of users 507. The sponsor may also receive commission from any number of users with an upline connection to the users that have an immediate upline connection to the sponsor. For example, Sponsor 501 may receive commission from the any number of users 507, as the any number of users 507 has an immediate upline connection 506 to the User/Sponsor 503 that has an immediate upline connection 504 to the Sponsor 501. Further, a sponsor may receive commission from users the sponsor has recruited if the user is not in their downline via a sponsor connection, such as the User/Sponsor 503 receiving commission via the sponsor connection 510 from the new user 508. Depending on the position of the user in the organization hierarchy, the rate of commission may vary. Additionally, the commission rate may vary based on the relationship between the users. A sponsor may receive one rate of commission from the user whereas an upline may receive a different rate of commission from the user. The rate of commission may also vary based on amount of sales exceeding a certain threshold value. For example, a sale under $500 may grant 5% in commission whereas a sale over $500 may grant 10% in commission.

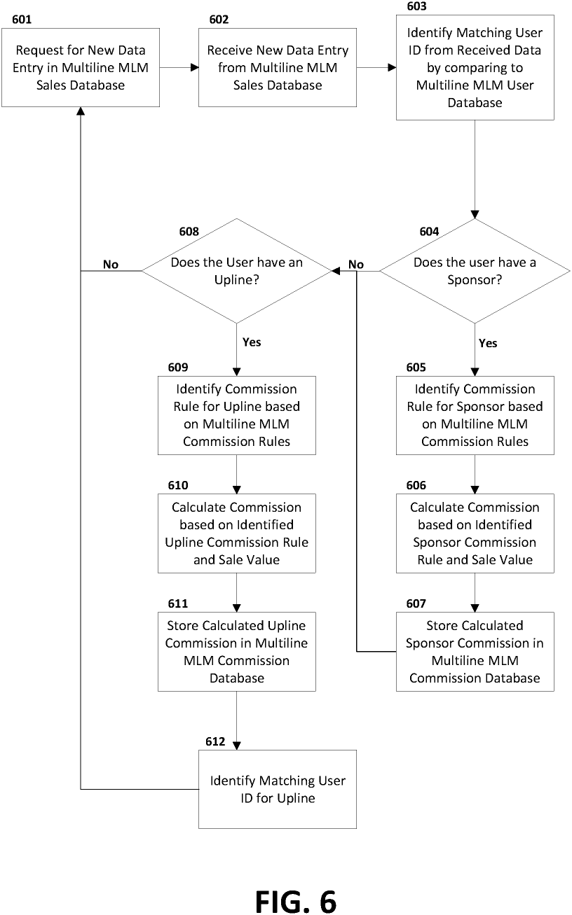

FIG. 6 illustrates a Multiline MLM Commission Module. The Multiline MLM Commission Module 104 may request a new data entry from the Multiline MLM Sales Database 103 at step 601. The new data entry may include any new sales data not yet processed by the Multline MLM Commission Module 104. New sales data may include information about a user and a sale associated with the user including a user ID, a sale value, a sale date, among other information. At step 602, The Multiline MLM Commission Module 104 may receive the new data entry and may compare it to the Multiline MLM User Database 102 to identify the user that made the sale in step 603. Identifying the user in the Multiline MLM User Database 102 may include identifying information associated with the position of the user in the Multiline MLM User Structure, other users in the upline or downline of the user, a sponsor of the user, and various other user information associated with the user. At step 604, the Multiline MLM Commission Module 104 may determine if the user has a sponsor. If the user does not have a sponsor, the Multiline MLM Commission Module 104 may skip to step 608. If the user has a sponsor, the Multiline MLM Commission Module 104 may identify a commission rule for the sponsor connection based on the Multiline MLM Commission Rules Database 105 at step 605. For example, the commission rule for the sponsor connection may include a percentage commission owed to the sponsor irrespective of the sponsor being in the upline of the user, such as 5% of the sale value.

At step 606, the Multiline MLM Commission Module 104 may calculate the commission owed to the sponsor based on the identified sponsor connection commission rule and the sale value of the user sale. For example, the user may have made a sale for $100, and the sponsor connection commission rule may state that the sponsor of the user should receive 5% of the sale value for a commission total of $5. In step 607, the Multiline MLM Commission Module 104 may store the calculated sponsor commission total in the Multiline MLM Commission Database 106. The stored commission total may be stored and associated with various users for different reasons. For example, the commission total may be stored associated with the sponsor user ID as commission paid by the specific user to the sponsor, added to the total commission earned for the sponsor, associated with the selling user ID as the commission paid by the specific user, or in any similar combination. At step 608, the Multiline MLM Commission Module 104 may identify if the user has an upline user that is owed commission who not the sponsor of the user. The commission to be paid by the user may be calculated differently for a sponsor, an upline and an upline who is also a sponsor. Similar to steps 605-607, the Multiline MLM Commission Module 104 identifies commission rules for the upline user of the selling user at step 609, calculates commission for the upline user based on one or more commission rules and the sale value at step 610, and stores the calculated commission in the Multiline MLM Commission Database 106 at step 611. At step 612, the Multiline MLM Commission Module 104 may identify if there is commission for additional upline users that has not yet been calculated. If the upline user ID does not match any upline user IDs that have already had commission calculated, the new upline user ID is processed by returning to step 608. If the upline user ID does match an upline user ID that has already had commission calculated and there is no additional upline user ID to process, the Multline MLM Commission Module restarts the process, at step 601.

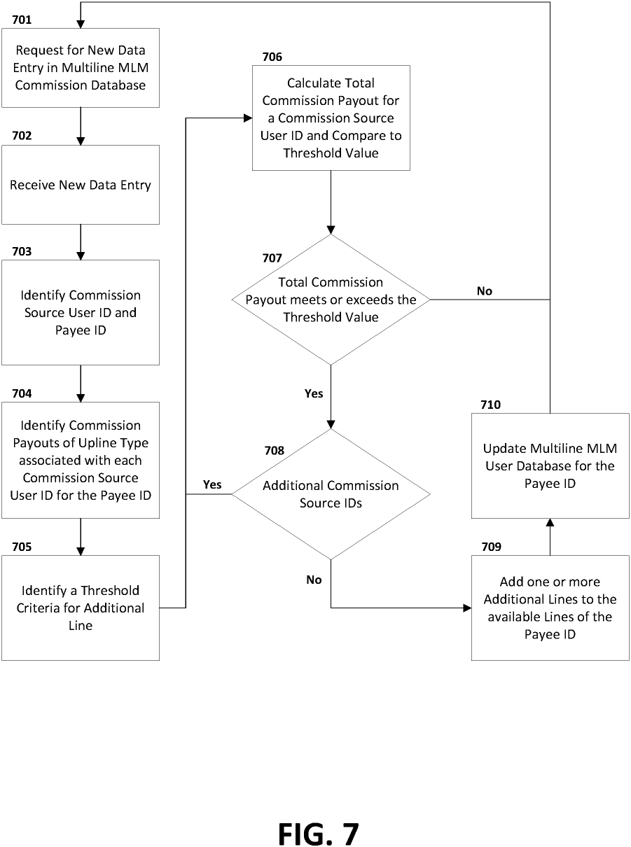

FIG. 7 illustrates a Multiline MLM Additional Line Module. At step 701 Multiline MLM Additional Line Module 107 may request a new data entry from the Multiline MLM Commission Database 106. The new data entry may include commission data not yet processed by the Multiline MLM Additional Line Module 107. At step 702, the Multiline MLM Additional Line Module 107 receives the new commission data entry. Attributes of the commission data entry such as a commission source user ID, a payee ID, a commission type, a commission payout value, a payment date, among other information may be identified by the Multiline MLM Additional Line Module 107 at step 703. At step 704, the Multiline MLM Additional Line Module 107 identifies and separates commission payouts with the commission type “upline” from commission payouts with the commission type “sponsor.” In some embodiments, additional commission lines may be added to a user based only on commissions received from the downline of the user and may not be based on commission paid to the sponsor of the user.

At step 705, the Multiline MLM Additional Line Module 107 may identify a threshold criteria for addition an additional line that must be met or surpassed by each commission source user ID associated with the payee ID. Such criteria may include one or more threshold values a user must meet from sales and received commission. There may be a threshold value for total commission received from the downlines of the user, another threshold value for commission received from each of the downlines of the user, and yet another threshold for the total sales that the user has made. The threshold values may vary for each users based on the data regarding the user, such as the position of the user in the Multiline MLM structure, the number of downlines the user already has, and the relationship between the users. The threshold criteria may be weighted based on the relationship between the users. For example, the commission type “upline” may be considered more heavily than the commission type “sponsor” in determining whether the threshold criteria to create an additional line has been met.

In step 706, the Multiline MLM Additional Line Module 107 may calculate the total commission payout from a source user ID including previously paid commission and any new or unprocessed commission from the source user ID. Total commission payouts may be calculated based on a variety of rules, which may consider the total lifetime commission from the downline user, the commission from the downline user over a certain period of time, and the commission from a type of product. The Multiline MLM Additional Line Module 107 may compare the calculated total commission payout to the threshold value of commission payouts. Based on the calculation in step 706, the Multiline MLM Additional Line Module 107 may determine if the total commission paid to the payee ID is greater than, equal to, or less than the threshold value of commission payouts.

In step 707, if the total commission payout from the source user ID does not meet or exceed the threshold value, the payee ID user may not receive an additional line, and the process restarts at step 701. If the total commission payout from the source user ID does meet or exceed the threshold value, the Multiline MLM Additional Line Module 107 may identify an additional commission source ID that has not yet been processed at step 708. If the Multiline MLM Additional Line Module 107 identifies an additional commission source ID, the process returns to step 706, and repeats for the new commission source ID. If the Multiline MLM Additional Line Module 107 does not identify any additional commission source ID, one or more additional lines may be added to the available lines of the payee ID at step 709. The Multiline MLM Additional Line Module 107 may execute a variety of rules associated with adding one or more additional lines to the payee ID based on the position of the user in the Multiline MLM organization, total lines available to the user, total commission paid to the user, number of users that the user has sponsored, or any combination of rules. In some embodiments, the Multiline MLM Additional Line Module 107 may add multiple additional lines to the available lines for the user.

In step 710, the Multiline MLM Additional Line Module 107 may update the Multiline MLM User Database 102 for the payee ID with the one or more additional lines. In some embodiments, the one or more additional lines may include no users, or may include users with no sales data. If an additional line includes no users or no sales data, the Multiline MLM Additional Line Module 107 may enter a placeholder nominal value or null value in the Multiline MLM User Database 102 that may later be replaced by user and sales data. The Multiline MLM Additional Line Module 107 may repeat the process at step 701 upon conclusion of updating the Multiline MLM User Database 102.

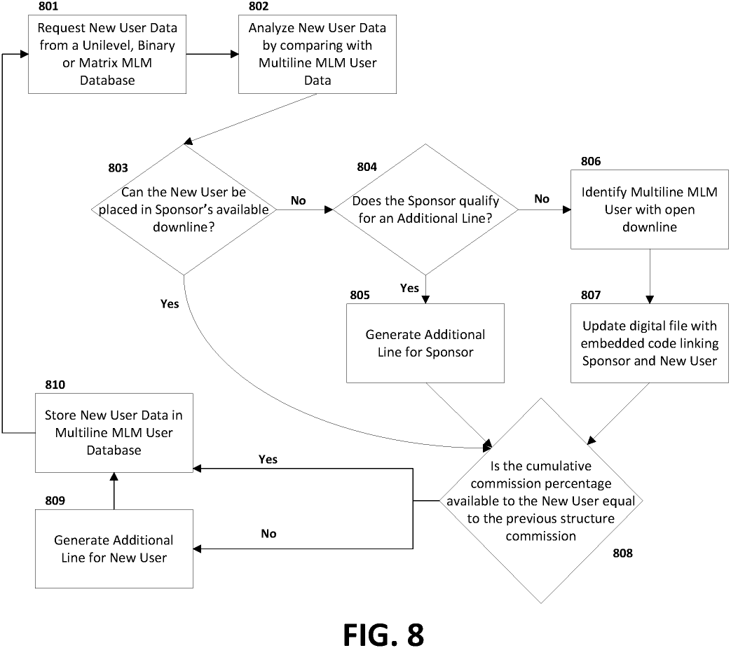

FIG. 8 illustrates a Multiline MLM Merger Module. At step 801, the Multiline MLM Merger Module 108 requests and receives new user data from a First MLM Database. The First MLM Database may include the 111 First Base Module, 112 First User Database, the 113 First Rules Database, or any combination of databases. The new user data may contain various user data records related to the user within the First MLM such as the user ID, sales value, commission earned, upline connections, downline connections, sponsor ID, commission rules associated with the user and user position in the First MLM, among other data. The relationships between users in the First MLM are embedded with a unique code and saved in a digital file in the Multiline User Database 104. Such code may be used to create and maintain the upline and downline relationship and to calculate commissions.

The unique code may be assigned or obtained by a new user via an online interaction (e.g., an online purchase) with a specific product webpage associated with the code. A link to the product webpage may be provided to the new user via a universal resource locator (URL) or an embedded URL in which the embedded unique code provides referral information associated with a upline user. When the new user engages in an online interaction with the product webpage, a new unique code is generated for the new user. The new unique code provides that the new user becomes related to the upline user as well as other distributors that previously purchased the product. Users that subsequently use the new link may each be given a respective different unique code that provides the respective set of upline users. After an online interaction meets certain conditions (e.g., a product purchased at the website), commissions may be paid out to the associated set of upline users specified by the unique code embedded in the link according to a defined commission levels.

At step 802, the Multiline MLM Merger Module 108 may analyze the new user data from the First MLM by comparing the new user data to the user data saved in the Multiline MLM User Database 102. Comparing user data between the First MLM and Multiline MLM may be executed using various different algorithms to match the First MLM user data to the sponsor, upline and downline users, and relative position within the First MLM organization.

At step 803, the Multiline MLM Merger Module 108 determines whether the new user can be placed downline of the sponsor of the user. If the sponsor has available space for a downline user, the Multiline MLM Merger Module may skip to step 808. If the sponsor of the user does not have available space for a downline user, the Multiline MLM Merger Module 108 may proceed to step 804. The Multiline MLM Merger Module 108 may then identify if the sponsor qualifies for an additional line by executing the process for the Multiline MLM Additional Line Module 107 described in FIG. 7. If the sponsor qualifies for an additional line, the Multiline MLM Additional Line Module 107 may generate an additional line for the sponsor at step 805. The Multiline MLM Merger Module 108 may store the new user data in the new additional line of the sponsor and may proceed to step 808. In this case, the existing relationships in the previous organization are maintained.

If the sponsor does not qualify for an additional line, the Multiline MLM Merger Module 108 may identify another user in the Multiline MLM with an open downline user available at step 806. The identified user may be selected at random or selected based on position in the organization, the number of available downlines, and the number of total downlines the user has. The Multiline MLM Merger Module 108 may store the data associated with the new user who is in the downline of the identified user.

At step 807, the Multiline MLM Merger Module 108 may update the digital file associated with the new user data and the sponsor user data. The upline and downline relationship between the new user and the sponsor is severed and the new user and the sponsor are linked in a crossline relationship. The digital file is embedded with a new unique code and the Multiline MLM User Database is updated accordingly with the new unique code.

At step 808, the Multiline MLM Merger Module 108 may compare commission data associated with the new user received from the First MLM to the commission data and rules for the position of the new user in the Multiline MLM. Various mathematical procedures may be executed to calculate an equivalent commission rate that the user could receive from the downline. In some embodiments, if the commission rate for the new user in the Multiline MLM is less than the commission rate for the same user in the First MLM, the Multiline MLM Merger Module 108 may generate an additional downline for the new user at step 809. In other words, if the user is expected to receive less commission in the Multiline MLM than what the user used to receive in the First MLM, the user may be entitled to additional downlines until the user could receive comparable commission in the Multiline MLM. In another embodiment, the Multiline MLM Merger Module 108 may send a request for a change in commission rules to the Multiline MLM Commission Rules Database 105, and may update the commission rules of the new user in the Multiline MLM to equal the commission rate for the user in the First MLM. Various requests may be made to a combination of databases available in the Multiline MLM in order to adjust the available commission rate to be equal or comparable to the previous commission rate in the First MLM.

At step 810, the Multiline MLM Merger Module 108 may store the new user data in the Multiline MLM User Database 102 and any other database of the Multiline MLM that contains updated information for the user. The Multiline MLM Merger Module 108 may proceed back to step 801 and may repeat the process until all available users in the First MLM have been created in the Multiline MLM User Database 102. Further, the Multiline MLM Merger Module 108 may repeat step 801 through step 810 for a Second MLM, or any number of additional MLM organizations.

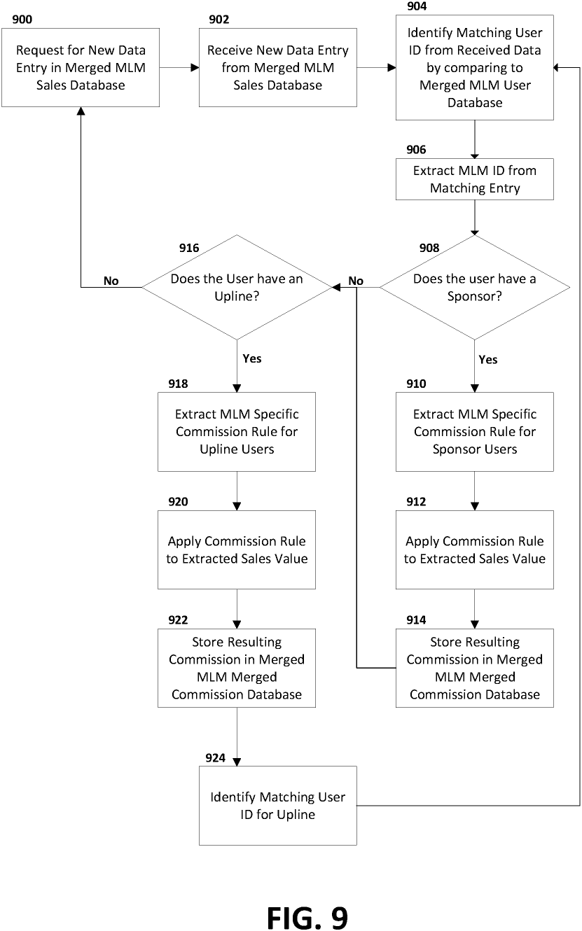

FIG. 9 illustrates a Merged MLM Merged Commission Module. The process begins with the 144 Merged MLM Merged Commission Module polling for a new data entry in the 143 Merged MLM Merged Sales Database, for example, when a sale is made by a user, at step 900. The 144 Merged MLM Merged Commission Module extracts the new data entry from the 143 Merged MLM Merged Sales Database which includes at least a user ID, sales value, and date, at step 902. The 144 Merged MLM Merged Commission Module searches for a User ID in the 142 Merged MLM Merged User Database that matches the user ID extracted from the 143 Merged MLM Merged Sales Database. For example if the extracted user ID had a value of “UL002” then the 144 Merged MLM Merged Commission Module will search the 142 Merged MLM Merged User Database for a value of “UL002” in the “User ID” category. The 144 Merged MLM Merged Commission Module selects the entry in the 142 Merged MLM Merged User Database with a matching user ID value, at step 904. The 144 Merged MLM Merged Commission Module extracts the MLM ID of the selected entry in the 142 Merged MLM Merged User Database, at step 906. The 144 Merged MLM Merged Commission Module determines if the user has a sponsor by checking the entry for a value in the “Sponsor User ID” category. If there is no value, or the value does not correspond to a user ID then the 144 Merged MLM Merged Commission Module will skip to step 916, at step 908. If there is a value that corresponds to a user ID in the “Sponsor User ID” category, the 144 Merged MLM Merged Commission Module extracts the commission rule from the 145 Merged MLM Merged Commission Rules Database for sponsor users that matches the extracted MLM ID, at step 910. The 144 Merged MLM Merged Commission Module applies the extracted commission rule to the sales value extracted from the 143 Merged MLM Merged Sales Database. For example if the rule is 10% commission for sponsors and the sales value is $300, then $300 will be multiplied by 10% to get $30 which is the commission payable to the sponsor, in an embodiment the sponsor may be paid directly by the 144 Merged MLM Merged Commission Module after this step, at step 912. The 144 Merged MLM Merged Commission Module stores the resulting commission in the 146 Merged MLM Merged Commission Database along with the user ID of the sponsoring user to be paid, the user ID of the sponsored user, the commission type, in this case sponsor, and the date extracted from the 143 Merged MLM Merged Sales Database, in some embodiments the date may be changed to reflect a delay in the processing of the commission or payment of the commission, at step 914. The 144 Merged MLM Merged Commission Module determines if the user has an upline user by checking the entry for a value in the “Upline User ID” category. If there is no value, or the value does not correspond to a user ID then the 144 Merged MLM Merged Commission Module will return to polling for a new data entry in the 143 Merged MLM Merged Sales Database, at step 916. If there is a value that corresponds to a user ID in the “Upline User ID” category, the 144 Merged MLM Merged Commission Module extracts the commission rule from the 145 Merged MLM Merged Commission Rules Database for upline users that matches the extracted MLM ID, at step 918. The 144 Merged MLM Merged Commission Module applies the extracted commission rule to the sales value extracted from the 143 Merged MLM Merged Sales Database. For example if the rule is 10% commission for upline users and the sales value is $300, then $300 will be multiplied by 10% to get $30 which is the commission payable to the upline user. In some embodiments users may receive a different commission based on how many levels upline they are from the user who made the sale. For example, the upline user of the upline user may earn 5% commission, and next upline user may earn 1% commission. In an embodiment the upline user may be paid directly by the 144 Merged MLM Merged Commission Module after this step, at step 920. The 144 Merged MLM Merged Commission Module stores the resulting commission in the 146 Merged MLM Merged Commission Database along with the user ID of the upline user to be paid, the user ID of the downline user, the commission type, in this case upline, and the date extracted from the 143 Merged MLM Merged Sales Database. In some embodiments the date may be changed to reflect a delay in the processing of the commission or payment of the commission, at step 922. The 144 Merged MLM Merged Commission Module then searches the 142 Merged MLM Merged Multiline User Database for an entry where the user ID in the “User ID” category matches the user ID in the “Upline User ID” category of the currently selected entry. at step 924. The 144 Merged MLM Merged Commission Module selects the entry with the matching user ID value as the new selected entry and returns to step 904.

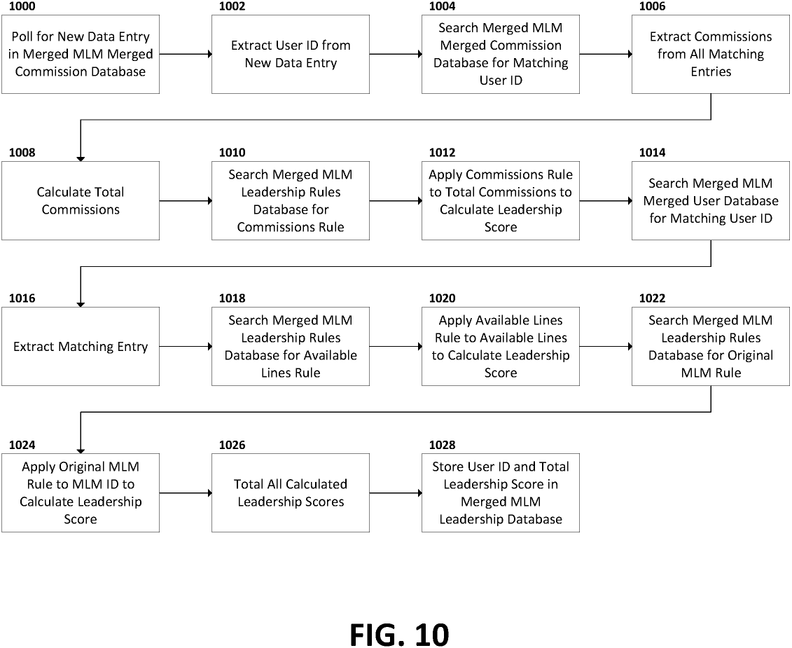

FIG. 10 illustrates a Merged MLM Leadership Module. The process begins with the 147 Merged MLM Leadership Module polling for a new data entry in the 146 Merged MLM Merged Commission Database, at step 1000. The 147 Merged MLM Leadership Module extracts the user ID from the “User ID” category of the extracted new entry, at step 1002. The 147 Merged MLM Leadership Module searches the 146 Merged MLM Merged Commission Database for all entries that have a matching user ID in the “User ID” category, at step 1004. The 147 Merged MLM Leadership Module extracts the value in the “Commission Value” category for all matching entries. In some embodiments, (for example) the 147 Merged MLM Leadership Module may only extract the commission value from a subset of matching entries. For example, only entries from the past 3 months, or only entries with “upline” in the “Commission Type” category, at step 1006. The 147 Merged MLM Leadership Module calculates the total commission by adding up all the extracted values. In some embodiments specific entries may be weighted and only a portion may be added. For example, entries made in the last 7 days may only have half of their value included, at step 1008. The 147 Merged MLM Leadership Module searches the 149 Merged MLM Leadership Rules Database for the rule associated with commissions, at step 1010. The 147 Merged MLM Leadership Module applies the commission rule to the total commissions to calculate leadership score. For example if total commissions is $900 and the rule is “leadership score = (total commissions)^(½)” then leadership score will be 30. This score will be added to other calculated leadership scores to obtain the total leadership score, at step 1012. The 147 Merged MLM Leadership Module searches the 142 Merged MLM Merged User Database for an entry with a matching user ID to the extracted user ID, at step 1014. The 147 Merged MLM Leadership Module extracts the matching entry in the 142 Merged MLM Merged User Database, at step 1016. The 147 Merged MLM Leadership Module searches the 149 Merged MLM Leadership Rules Database for the rule associated with available lines, at step 1018. The 147 Merged MLM Leadership Module applies the available line rule to the available lines to calculate leadership score. For example if available lines is 7 and the rule is “leadership score = available lines * 10” then leadership score will be 70. This score will be added to other calculated leadership scores to obtain the total leadership score, at step 1020. The 147 Merged MLM Leadership Module searches the 149 Merged MLM Leadership Rules Database for the rule associated with MLM ID, at step 1022. The 147 Merged MLM Leadership Module applies the original MLM rule to the MLM ID to calculate leadership score. For example if MLM ID is MLM01 and the rule is “If MLM ID = MLM01, leadership score = 100, else leadership score = 0” then leadership score will be 100. This score will be added to other calculated leadership scores to obtain the total leadership score, at step 1024. The 147 Merged MLM Leadership Module calculates the total leadership score by adding the leaderships scores from each application of the leadership rules. For example, if the score is 30 from the commission rule, 70 from the available line rule, and 100 from the Original MLM rule, then the total will be 210. In some embodiments there may be a greater or lesser number of rules which may be applied to any parameter available such as, volume, line depth, total downline members, join date, etc., at step 1026. The 147 Merged MLM Leadership Module stores the user ID and the total leadership score in the 148 Merged MLM Leadership Database, if the user ID is already in the database then the entry will be edited, then the 147 Merged MLM Leadership Module returns to polling for a new data entry in the 146 Merged MLM Merged Commission Database, at step 1028.

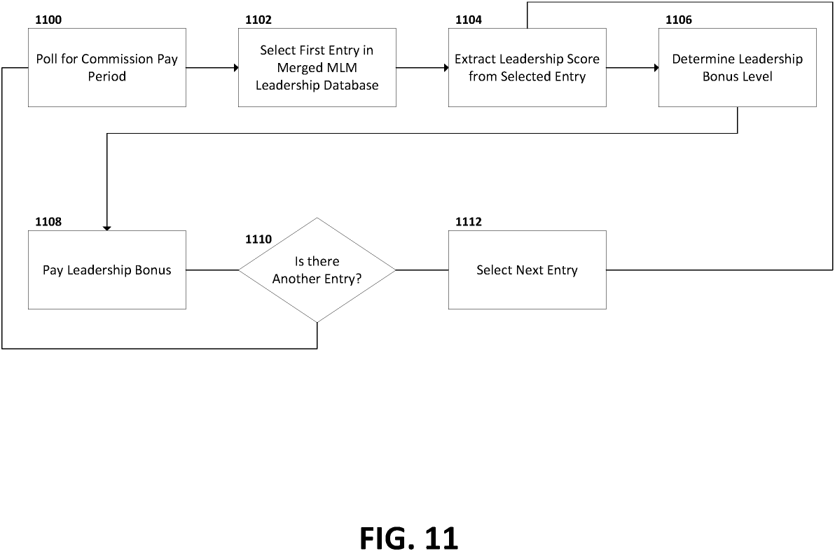

FIG. 11 illustrates a Merged MLM Leadership Bonus Module. The process begins with the 150 Merged MLM Leadership Bonus Module polling for the end of a commission pay period, which may be, for example, each month. In an embodiment commission may be paid based on a user meeting a commissions threshold, for example, $20, in which case the 150 Merged MLM Leadership Bonus Module will poll for a payment event. In an embodiment commission is paid continuously and the 150 Merged MLM Leadership Bonus Module may poll for new data in the 150 Merged MLM Commissions Database, at step 1100. The 150 Merged MLM Leadership Bonus Module selects the first entry in the 148 Merged MLM Leadership Database, at step 1102. The 150 Merged MLM Leadership Bonus Module extracts the value in the “Leadership Score” category of the selected entry, at step 1104. The 150 Merged MLM Leadership Bonus Module determines the leadership bonus level based on the extracted value. For example, a value less than 100 may correspond to a leadership level of 0, a value between 100-500 may correspond to a leadership level of 1, a value between 500-2500 may correspond to a leadership level of 2, etc., leadership score to leadership bonus conversion may involve complex equations and may be static or dynamic, at step 1106. The 150 Merged MLM Leadership Bonus Module pays a leadership bonus to the user corresponding to the user ID in the selected entry. In an embodiment the leadership bonus is stored in the 146 Merged MLM Commissions Database and payment is completed via another module. The leadership bonus may be a direct bonus, for example, $100 for leadership level 1, $300 for leadership level 2, etc., or may be a percent increase to commissions rate, for example, 2% more for leadership level 1, 5% more for leadership level 2, etc. The leadership bonus may be static or dynamic, at step 1108. The 150 Merged MLM Leadership Bonus Module determines if there are any other entries in the 148 Merged MLM Leadership Database. If not, the 150 Merged MLM Leadership Bonus Module returns to step 1100, at step 1110. If there are any other entries in the 148 Merged MLM Leadership Database, the 150 Merged MLM Leadership Bonus Module selects the next entry and returns to step 1104, at step 1112.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

What is claimed is:

1. (canceled)

2. A method for merging at least two user structures into a multiline user structure, the method comprising:
storing information in a database regarding at least a first user structure with a first set of lines corresponding to existing relationships and a second user structure with a second set of lines corresponding to existing relationships;
receiving data for at least one member of the first user structure or the second user structure, the data regarding at least a position of the at least one member within the respective user structure and corresponding to a set of relationships of the at least one member;
merging the first user structure and the second user structure to create a new merged multiline user structure that includes the at least one member, wherein the set of relationships of the at least one member is integrated into and maintained within the merged multiline user structure;
storing the merged multiline user structure in memory, wherein the merged multiline user structure is updateable to add one or more additional lines corresponding to new relationships with the at least one member;
monitoring performance of the at least one member in the merged multiline user structure over one or more periods of time; and
awarding a leadership score based on the monitored performance.

3. The method of claim 2, wherein the at least one member of the merged structure is allowed to add additional lines until a threshold maximum number is reached.

4. The method of claim 3, wherein the threshold maximum number is raised based on meeting threshold criteria.

5. The method of claim 4, wherein meeting the threshold criteria is based on weighting one or more relationships between the at least one member and one or more downline members of the at least one member.

6. The method of claim 2, further comprising adding the additional lines based on identifying a unique code associated with the at least one member.

7. The method of claim 6, wherein the unique code is an embedded uniform resource location (URL) of a webpage for a product.

8. The method of claim 7, further comprising generating a new unique code based on the unique code when a new member interacts with the webpage.

9. The method of claim 8, further comprising creating a relationship between the new member and the at least one member based on the new unique code.

10. The method of claim 9, further comprising identifying one or more upline members of the at least one member based on the data for the at least one member.

11. The method of claim 10, further comprising continuously distributing a specified amount of distribution to the at least one member and the one or more upline members based on information encoded in the unique code.

12. The method of claim 11, wherein the specified amount of distribution to the at least one member is based on a performance of one or more downline members of the at least one member, and wherein the leadership score is further based on the specified amount of distribution.

13. The method of claim 12, further comprising weighting the leadership score based on one or more parameters, wherein the parameters include a depth of relationship between the at least one member and the one or more downline members of the at least one member.

14. The method of claim 2, further comprising modifying a set of downline relationships of the at least one member of the first user structure if the set of downline relationships exceeds a threshold maximum number.

15. The method of claim 14, wherein modifying the set of downline relationships includes identifying another member in the merged structure based on a position of the at least one member of the first user structure.

16. The method of claim 15, wherein modifying the set of downline relationships includes creating a relationship between a new member to the other member.

17. The method of claim 16, wherein modifying the set of downline relationships includes severing a previous relationship between the new member and the at least one member and creating a different relationship between the new member and the at least one member.

18. The method of claim 16, further comprising storing the data in a user database, wherein the data is updated based on the modification to the set of downline relationships.

19. A system for merging at least two user structures into a multiline user structure, the system comprising:
a first database that stores information regarding a first user structure with a first set of lines corresponding to existing relationships;
a second database that stores information regarding a second user structure with a second set of lines corresponding to existing relationships;
a merger module in communication with the first database and the second database, wherein the merger module is executable by a processor to merge the first user structure and the second user structure to create a new merged multiline user structure that includes at least one member, wherein the set of relationships of the at least one member is integrated into and maintained within the merged multiline user structure;
a multiline database that stores the merged multiline user structure in memory, wherein information regarding performance of the at least one member in the merged multiline user structure is monitored over one or more periods of time; and
a leadership module that assigns a leadership score is assigned based on the monitored performance.

20. A non-transitory computer-readable storage medium, having embodied thereon a program executable by a processor to perform a method for merging at least two user structures into a multiline user structure, the method comprising:
storing information in a database regarding at least a first user structure with a first set of lines corresponding to existing relationships and a second user structure with a second set of lines corresponding to existing relationships;
receiving data for at least one member of the first user structure or the second user structure, the data regarding at least a position of the at least one member within the respective user structure and corresponding to a set of relationships of the at least one member;
merging the first user structure and the second user structure to create a new merged multiline user structure that includes the at least one member, wherein the set of relationships of the at least one member is integrated into and maintained within the merged multiline user structure;
storing the merged multiline user structure in memory, wherein the merged multiline user structure is updateable to add one or more additional lines corresponding to new relationships with the at least one member;
monitoring performance of the at least one member in the merged multiline user structure over one or more periods of time; and
awarding a leadership score based on the monitored performance.
